(19) United States
(12) Patent Application Publication
(10) Pub. No.: US 2025/0256976 A1
(43) Pub. Date: Aug. 14, 2025

(54) LITHIUM CARBONATE, METHOD FOR PREPARING LITHIUM CARBONATE, AND RECHARGEABLE LITHIUM BATTERY INCLUDING POSITIVE ELECTRODE ACTIVE MATERIAL PREPARED USING THE METHOD

(71) Applicant: SAMSUNG SDI CO., LTD., Yongin-si (KR)

(72) Inventors: Eunok OH, Yongin-Si Gyeonggi-do (KR); Kieun Park, Yongin-Si Gyeonggi-do (KR)

(21) Appl. No.: 19/048,316

(22) Filed: Feb. 7, 2025

(30) Foreign Application Priority Data
Feb. 8, 2024 (KR) 10-2024-0019935
Oct. 25, 2024 (KR) 10-2024-0147149

(51) Int. Cl. C01D 15/08; H01M 10/052

(52) U.S. Cl. CPC C01D 15/08; H01M 10/052; C01P 2002/74; C01P 2004/03; C01P 2004/20; C01P 2004/54; C01P 2004/61; C01P 2006/40; C01P 2006/80

(57) ABSTRACT

Provided are a method for preparing a lithium carbonate, a lithium carbonate prepared using the same, and a rechargeable lithium battery including a positive electrode active material prepared using the same, and more particularly, to a method for preparing a lithium carbonate, including mixing a lithium nickel-based composite oxide and a coating solution to form a first mixture where the coating solution includes a coating raw material, a precipitant, and a solvent, filtering the first mixture to recover a washing solution containing at least 1000 ppm of lithium, filtering the washing solution, mixing and heating the filtered washing solution and sodium carbonate to form a second mixture, and filtering, washing, and drying the second mixture, wherein the heating is performed at a temperature of about 50° C. to about 80° C.

### CROSS-REFERENCE TO RELATED APPLICATIONS

This U.S. non-provisional patent application claims priority to and the benefit under 35 U.S.C. § 119(a)-(d) of Korean Patent Application No. 10-2024-0019935, filed on Feb. 8, 2024, and Korean Patent Application No. 10-2024-0147149, filed on Oct. 25, 2024, the entire disclosures of which are incorporated by reference herein.

### BACKGROUND

### Field

The present disclosure relates to a method for preparing a lithium carbonate, a lithium carbonate prepared implementing the method, and a rechargeable lithium battery including a positive electrode active material prepared implementing the method.

### Description of the Related Art

Rechargeable lithium batteries are utilized as energy storage and supply sources in a broad range of applications. Such applications include portable devices, such as smartphones, tablets, wearables, laptops, digital cameras, and power tools, and various aspects of transportation, such as hybrid cars, electric vehicles, and electric boards, rechargeable lithium batteries. Nowadays, rechargeable lithium batters are used in industries such as drones, robots, and Urban Air Mobility (UAM).

Awareness of climate change and increasing interest in eco-friendliness have driven significant growth in the electric vehicle market, resulting in a sharp rise in the use of rechargeable lithium batteries. However, as essential raw materials for manufacturing rechargeable lithium batteries come from natural resources, extraction of these raw materials inevitably leads to environmental damage and pollution. Consequently, there is a pressing need for developing technology related to recycling these raw materials.

Accordingly, methods for recovering valuable metals, such as transition metal precursors and lithium precursors, from waste rechargeable lithium batteries and waste related to rechargeable lithium batteries, including waste generated from a rechargeable lithium battery manufacturing process and wastewater generated from a positive electrode active material washing process, are drawing significant attention, where recovered valuable metals may be reused for manufacturing rechargeable lithium batteries. Research and development are actively underway to develop recycling methods that are environmentally friendly, cost-conscious, and capable of recovering relatively high concentrations of valuable metals.

Various methods are in place to recover valuable metals from waste rechargeable lithium batteries or waste generated from a rechargeable lithium battery manufacturing process. However, these typical methods require the use of relatively large amounts of basic solutions during the recovery process. Considering that byproducts of basic solutions are detrimental to the environment, there is a need to develop alternatives to these basic solutions.

Also, various methods are in place to recover lithium precursors from wastewater from a positive electrode active material washing process. The wastewater from the washing of a positive electrode active material usually contains a substantial amount of lithium. However, these typical methods require a separate, independent process to recover lithium precursors from the wastewater. In addition, given that no process is capable of achieving 100% recovery, the separate, independent process would necessarily entail lithium losses. Thus, there is a need to develop an enhanced method for recovering lithium precursors.

### SUMMARY

The present disclosure provides a rechargeable lithium battery exhibiting excellent high-temperature lifespan characteristics, and a lithium carbonate for preparing a positive electrode active material included in the rechargeable lithium battery, and a method for preparing the same.

Embodiments of the present disclosure provide a method for preparing a lithium carbonate, including mixing a lithium nickel-based composite oxide and a coating solution to form a first mixture where the coating solution includes a coating raw material, a precipitant, and a solvent, filtering the first mixture to recover a washing solution containing at least 1000 ppm of lithium, filtering the washing solution, mixing and heating the filtered washing solution and sodium carbonate to form a second mixture, and filtering, washing, and drying the second mixture, wherein the heating is performed at a temperature of about 50° C. to about 80° C.

In an embodiment, a lithium carbonate is prepared through the above-described preparation method and has a plate shape.

In an embodiment, a rechargeable lithium battery includes a positive electrode active material prepared by mixing and heat treating the lithium carbonate described above and a transition metal-containing compound.

Embodiments of the present disclosure provide a method for preparing a lithium carbonate, including combining a lithium nickel-based composite oxide and a coating solution to form a first mixture, wherein the coating solution includes a coating raw material; recovering a washing solution from the first mixture, wherein the washing solution includes at least 1000 ppm of lithium; combining the washing solution and sodium carbonate to form a second mixture; and heating the second mixture.

In an embodiment, the lithium nickel-based composite oxide has a nickel content of about 80 mol % to about 100 mol % among metals excluding lithium.

In an embodiment, the coating raw material includes a cobalt compound.

In an embodiment, the cobalt compound includes at least one selected from the group of cobalt nitrate, cobalt sulfate, cobalt oxide, cobalt hydroxide, and cobalt carbonate.

In an embodiment, the coating solution further includes a precipitant and a solvent.

In an embodiment, the precipitant includes at least one selected from the group of sodium hydroxide, lithium hydroxide, potassium hydroxide, and ammonia.

In an embodiment, the washing solution includes about 3500 ppm to about 5000 ppm of lithium.

In an embodiment, the washing solution comprises impurities at a concentration of about 20 ppm to about 40000 ppm.

In an embodiment, the heating is performed for 30 to 300 minutes.

In an embodiment, the heating is performed at a temperature of about 50° C. to about 80° C.

In an embodiment, the method further includes filtering the washing solution.

In an embodiment, the method further includes filtering, washing, and drying the second mixture.

Embodiments of the present disclosure provide a lithium carbonate having a plate shape and including: a first width in a horizontal direction ranging from about 3.5 μm to about 15 μm; and a second width in a vertical direction ranging from about 0.5 μm to about 3 μm, wherein the lithium carbonate is configured to reduce activation energy of a reaction with a transition metal-containing compound to form a positive electrode active material of a rechargeable lithium battery.

In an embodiment, the lithium carbonate has an aspect ratio of about 10 to about 100.

In an embodiment, the lithium carbonate has a purity of about 95% to about 99.999%.

In an embodiment, in an XRD spectrum of the lithium carbonate using a Cu-Kα line, a ratio of a maximum intensity of a (002) plane to a maximum intensity of a (110) plane ranges from about 1.1 to about 2.

In an embodiment, in an XRD spectrum of the lithium carbonate using a Cu-Kα line, a full width at half maximum of a peak corresponding to the (110) plane ranges from about 0.300 degrees to about 0.500 degrees.

In an embodiment, in an XRD spectrum of the lithium carbonate using a Cu-Kα line, a full width at half maximum of a peak corresponding to the (002) plane ranges from about 0.100 degrees to about 0.177 degrees.

Embodiments of the disclosure provide a rechargeable lithium battery including the positive electrode active material.

In an embodiment, the positive electrode active material comprises a lithium nickel-based composite oxide having a nickel content of about 60 mol % to about 100 mol % among metals excluding lithium.

In an embodiment, the rechargeable lithium battery has a capacity retention of at least 90% when charged and discharged 30 times at 1 C/1 C at 45° C.

### BRIEF DESCRIPTION OF THE FIGURES

The following drawings attached to this specification illustrate embodiments of the present disclosure, and describe aspects and features of the present disclosure together with the detailed description of the present disclosure. The present disclosure is not limited to embodiments depicted in the drawings:

FIG. 1 is a schematic view showing a rechargeable lithium battery according to embodiments of the present disclosure;

FIGS. 2 to 5 are schematic views showing a rechargeable lithium battery according to embodiments of the present disclosure. FIG. 2 shows a cylindrical battery, FIG. 3 shows a cross-section of a prismatic battery, and FIGS. 4 and 5 show pouch type batteries;

FIG. 6 is a schematic view showing a lithium carbonate according to embodiments of the present disclosure;

FIG. 7 is an X-ray diffraction (XRD) spectrum of a lithium carbonate according to embodiments of the present disclosure;

FIG. 8 is a flowchart showing a method for preparing a lithium carbonate according to embodiments of the present disclosure;

FIG. 9 is a flowchart showing a method for preparing a lithium carbonate according to embodiments of the present disclosure;

FIG. 10 is a flowchart showing a method for preparing a lithium carbonate according to embodiments of the present disclosure;

FIG. 11 is a schematic view showing a method for preparing a lithium carbonate according to embodiments of the present disclosure;

FIG. 12 is a schematic view showing a method for preparing a lithium carbonate according to embodiments of the present disclosure;

FIG. 13 is a schematic view showing a lithium carbonate according to embodiments of the present disclosure;

FIG. 14 is a flowchart showing a method for preparing a positive electrode active material according to embodiments of the present disclosure;

FIG. 15 is a flowchart showing a method for preparing a positive electrode active material according to embodiments of the present disclosure;

FIG. 16 is a cross-sectional view showing a positive electrode active material according to embodiments of the present disclosure;

FIG. 17 shows a scanning electron microscope (SEM) images of a lithium carbonate according to embodiments of the present disclosure;

FIG. 18 shows SEM images of a lithium carbonate according to embodiments of the present disclosure;

FIG. 19 is an XRD spectrum showing lithium carbonate according to embodiments of the present disclosure; and

FIG. 20 is a graph showing high-temperature lifespan characteristics of rechargeable lithium batteries according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as being consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

Herein, it will be understood that when a component is referred to as being on another component, the component may be directly on another component, or an intervening third component may be present. In addition, in the drawings, thicknesses of components can be exaggerated for effectively describing technical contents. Like reference numerals refer to like elements throughout.

The embodiments described herein can be explained with reference to cross-sectional views and/or plan views as example views of the present disclosure. In the drawing, the thicknesses of films and regions can be exaggerated for effective description of technical contents. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof.

Terms used herein are not for limiting the present disclosure but for describing the embodiments. As used herein, the singular forms include the plural forms as well, unless the context clearly indicates otherwise. The meaning of “includes,” “including,” “comprises,” and/or “comprising,” used herein does not exclude the presence or addition of one or more other components besides a mentioned component.

As used herein, the term “combination thereof” may refer to a mixture, a stack, a composite, a copolymer, an alloy, a blend, or a reaction product.

Unless otherwise defined herein, a particle diameter may be an average particle diameter. In addition, a particle diameter can be defined as an average particle diameter (D50) indicating the diameter of particles having a cumulative volume of 50 volume % in the particle size distribution. The average particle diameter (D50) may be measured by a method widely known to those skilled in the art, for example, by a particle size analyzer, an image of transmission electron microscope (TEM), or an image of scanning electron microscope (SEM). Alternatively, an average particle diameter (D50) value may be obtained by measuring a subject using a dynamic light-scattering-based measuring device, performing data analysis, counting the number of particles for each particle size range, and then calculating the value therefrom. Alternatively, the average particle diameter (D50) may be measured using a laser diffraction method. In the measuring using the laser diffraction method, more specifically, target particles are distributed in a distribution solvent, introduced into a commercially available laser diffraction particle diameter measuring device (e.g., MT 3000 available from Microtrac, Ltd.), irradiated with ultrasonic waves of about 28 kHz at a power of 60 W, and then an average particle diameter (D50) based on 50% of the particle diameter distribution in the measuring device may be calculated.

Throughout the specification, when “A and/or B” is stated, it means A, B or A and B, unless otherwise stated. That is, “and/of” includes any or all combinations of a plurality of items enumerated. When “C to D” is stated, it means C or more and D or less, unless otherwise specified. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed” between the components”.

Numerical ranges disclosed and/or recited herein include all sub-ranges of the same numerical precision subsumed within the recited ranges. For example, a range of “1.0 to 10.0” includes all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein includes all lower numerical limitations subsumed therein, and any minimum numerical limitation recited in this specification includes all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Terms used herein describe embodiments of the present disclosure and do not limit the present disclosure.

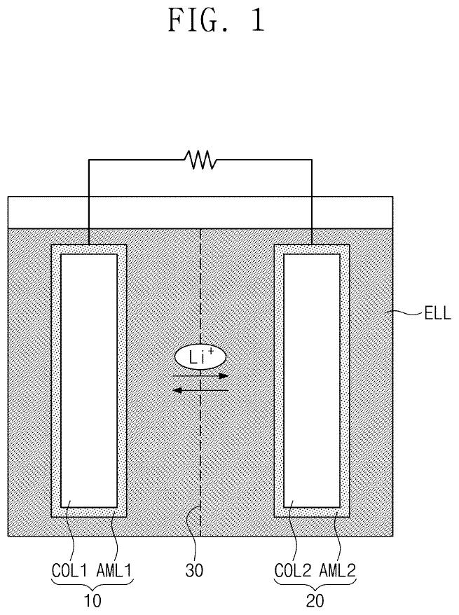

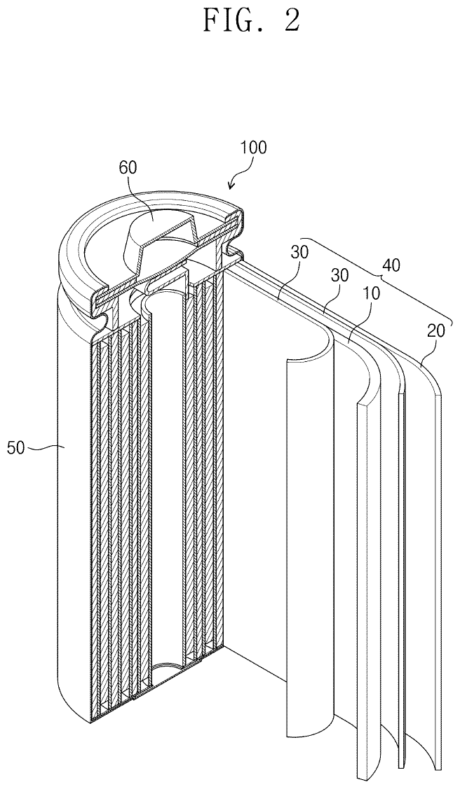

FIG. 1 is a cross-sectional schematic view of a rechargeable lithium battery (e.g., 100 of FIGS. 2 to 5) according to embodiments of the present disclosure. The rechargeable lithium battery (e.g., 100 of FIGS. 2 to 5) may include a positive electrode 10, a negative electrode 20, a separator 30, and an electrolyte solution ELL.

The positive electrode 10 and the negative electrode 20 may be spaced apart from each other via the separator 30. The separator 30 may be positioned between the positive electrode 10 and the negative electrode 20. The positive electrode 10, the negative electrode 20 and the separator 30 may be in contact with the electrolyte solution ELL. The positive electrode 10, the negative electrode 20, and the separator 30 may be impregnated in the electrolyte solution ELL.

The electrolyte solution ELL may include a medium for transferring lithium ions between the positive electrode 10 and the negative electrode 20. In the electrolyte solution ELL, the lithium ions may migrate through the separator 30 toward the positive electrode 10 or the negative electrode 20.

### Positive Electrode 10

The positive electrode 10 for a rechargeable lithium battery may include a current collector COL1 and a positive electrode active material layer AML1 positioned on the current collector. The positive electrode active material layer AML1 may include a positive electrode active material and may further include a binder and/or a conductive material (e.g., an electrically conductive material).

In an embodiment, the positive electrode 10 may further include an additive that can be configured to serve as a sacrificial positive electrode.

The positive electrode active material may amount from about 90 wt % to about 99.5 wt % based on 100 wt % of the positive electrode active material layer AML1. Each of the binder and the conductive material may amount from about 0.5 wt % to about 5 wt % based on 100 wt % of the positive electrode active material layer AML1.

The binder is configured to adhere particles of the positive electrode active material to one another and also to adhere the positive electrode active material to the current collector COLL. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like.

The conductive material is configured to ensure conductivity (e.g., electrical conductivity) to the electrode. Any material that does not contribute to chemical change (e.g., does not contributed to an undesirable chemical change in the rechargeable lithium battery) while being capable of conducting electrons can be used in the battery. Non-limiting examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector COL1, but is not limited thereto.

### Positive Electrode Active Material

The positive electrode active material may include a compound (e.g., a lithiated intercalation compound) that is capable of intercalating and/or deintercalating lithium. In an embodiment, at least one of a composite oxide of lithium and a metal selected from cobalt, manganese, nickel, and combinations thereof may be used.

The composite oxide may include a lithium transition metal composite oxide. Non-limiting examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

In an embodiment, compounds represented by any one of the following chemical formulas may be used. LiₐA_{1-b}XbO_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8 0≤b≤0.9, 0≤c≤0.5, 0≤d≤0.5, and 0≤e≤0.1); LiₐNiG_{b}O₂(0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃(0≤f≤2); or LiₐFePO₄(0.90≤a≤1.8), where A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may include, as a non-limiting example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material, and may further include a binder and/or a conductive material (e.g., an electrically conductive material).

In an embodiment, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder is configured to adhere particles of the negative electrode active material to one another and also to adhere the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of enhancing viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material where the polymer material can be fibrous. As a non-limiting example, the dry binder may include polytetrafluoroethylene, polyvinylidene fluoride, a polyvinylidene fluoride-hexafluoropropylene copolymer, polyethylene oxide, or a combination thereof.

The conductive material is configured to ensure conductivity (e.g., electrical conductivity) to the electrode. Any material that does not contribute to chemical change (e.g., does not contribute to an undesirable chemical change in the rechargeable lithium battery) while being capable of conducting electrons can be used in the battery. Non-limiting examples of the conductive material may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector COL2 may include a copper foil, a nickel foil, a stainless steel foil, a titanium foil, a nickel foam, a copper foam, a polymer substrate coated with a conductive metal, or a combination thereof.

### Negative Electrode Active Material

The negative electrode active material may include a material capable of reversibly intercalating/deintercalating lithium ions, a lithium metal, a lithium metal alloy, a material capable of doping/dedoping lithium, or a transition metal oxide.

The material capable of reversibly intercalating/deintercalating lithium ions may include a carbon-based negative electrode active material, such as crystalline carbon, amorphous carbon or a combination thereof. The crystalline carbon may include graphite such as non-shaped, sheet-shaped, flake-shaped, sphere-shaped, or fiber-shaped natural graphite or artificial graphite. The amorphous carbon may include a soft carbon, a hard carbon, a mesophase pitch carbonization product, calcined coke, and the like.

The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may include a Si-based negative electrode active material or a Sn-based negative electrode active material. The Si-based negative electrode active material may include silicon, a silicon-carbon composite, SiOx (0<x<2), or a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may include a composite of silicon and amorphous carbon. In an embodiment, the silicon-carbon composite may exist in a form of silicon particles and amorphous carbon coated on the surface of the silicon particles. In an embodiment, the silicon-carbon composite may include a secondary particle (core) in which primary silicon particles are assembled, and an amorphous carbon coating layer (shell) on the surface of the secondary particle. The amorphous carbon may also exist between the primary silicon particles, and, in an embodiment, the primary silicon particles may be coated with the amorphous carbon. The secondary particle may exist dispersed in an amorphous carbon matrix.

The silicon-carbon composite may further include crystalline carbon. In an embodiment, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Separator 30

Depending on the type of the rechargeable lithium battery, the separator 30 may be present between the positive electrode 10 and the negative electrode 20. The separator 30 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 30 may include a porous substrate and a coating layer including an organic material, an inorganic material, or a combination thereof on one or both surfaces of the porous substrate.

The porous substrate may include a polymer film including polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed to form a single coating layer, or may separately exist as a coating layer including an organic material and a coating layer including an inorganic material, which may be stacked to each other.

### Electrolyte Solution ELL

The electrolyte solution ELL for a rechargeable lithium battery may include a non-aqueous organic solvent and a lithium salt.

The non-aqueous organic solvent is configured to serve as a medium for transmitting ions taking part in the electrochemical reaction of a battery.

The non-aqueous organic solvent may include a carbonate-based, ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like.

The ester-based solvent may include methyl acetate, ethyl acetate, n-propyl acetate, dimethyl acetate, methyl propionate, ethyl propionate, decanolide, mevalonolactone, valerolactone, caprolactone, or the like.

The ether-based solvent may include dibutyl ether, tetraglyme, diglyme, dimethoxyethane, 2-methyltetrahydrofuran, 2,5-dimethyltetrahydrofuran, tetrahydrofuran, or the like.

The ketone-based solvent may include cyclohexanone or the like.

The alcohol-based solvent may include ethanol, isopropyl alcohol, and the like and the aprotic solvent may include nitriles such as R-CN (wherein R is a C2 to C20 linear, branched, or cyclic hydrocarbon group, a double bond, an aromatic ring, or an ether bond, and the like; amides such as dimethylformamide; dioxolanes such as 1,3-dioxolane, 1,4-dioxolane, and the like; or sulfolanes, and the like.

The non-aqueous organic solvents may be used alone or in combination of two or more.

In addition, when using a carbonate-based solvent, a cyclic carbonate and a chain carbonate may be combined and used, and the cyclic carbonate and the chain carbonate may be combined in a volume ratio of about 1:1 to about 1:9.

The lithium salt dissolved in the organic solvent is configured to supply lithium ions in a battery, enable a basic operation of a rechargeable lithium battery, and improve transportation of the lithium ions between positive and negative electrodes. Non-limiting examples of the lithium salt include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(CyF_{2y+1}SO₂) (wherein x and y are integers of 1 to 20), lithium trifluoromethane sulfonate, lithium tetrafluoroethanesulfonate, lithium difluoro(oxalato)borate(LiDFOB), lithium difluorobis(oxalato)phosphate (LiDFBOP), or lithium bis(oxalato) borate (LiBOB).

### Rechargeable Lithium Battery 100

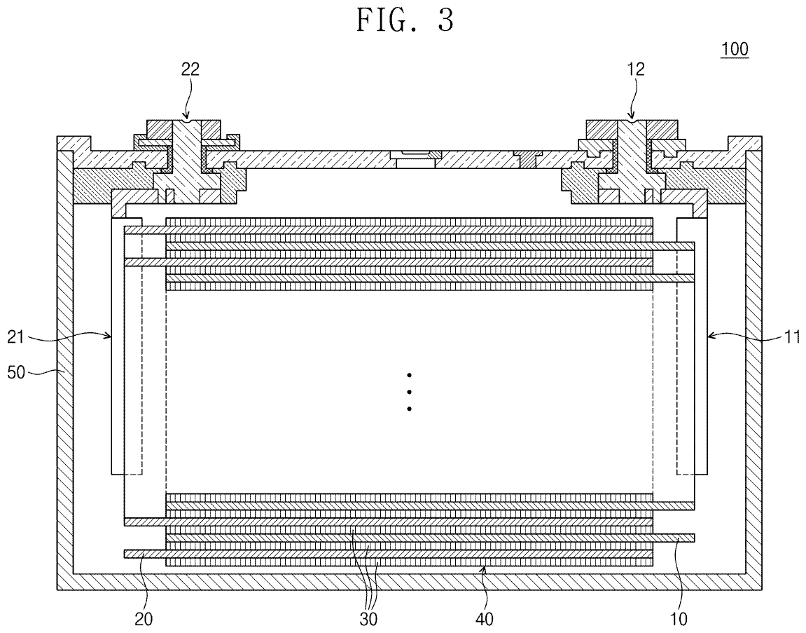

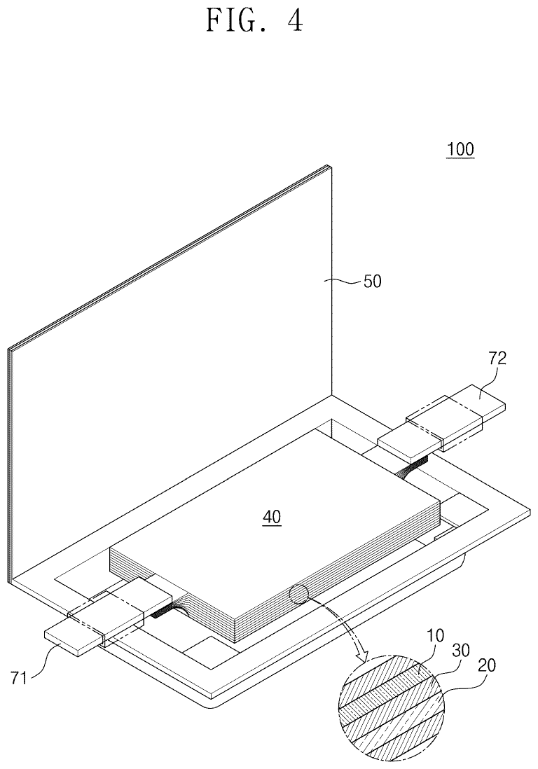

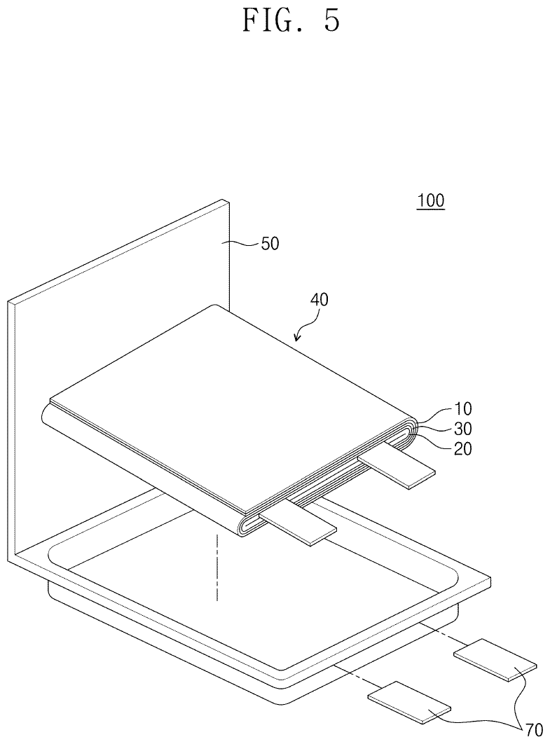

The rechargeable lithium battery 100 may be classified into cylindrical, prismatic, pouch, or coin-type batteries, and the like, depending on its shape. FIGS. 2 to 5 are schematic views showing a rechargeable lithium battery according to embodiments of the present disclosure. FIG. 2 shows a cylindrical battery, FIG. 3 shows a cross-section of a prismatic battery, and FIGS. 4 and 5 show pouch-type batteries.

The rechargeable lithium battery 100 may include an electrode assembly 40 including a separator 30 positioned between a positive electrode 10 and a negative electrode 20, and a case 50 encompassing the electrode assembly 40. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12, a negative lead tab 21, and a negative terminal 22. As shown in FIGS. 4 and 5, the rechargeable lithium battery 100 may include an electrode tab 70, which may be, for example, a positive electrode tab 71 and a negative electrode tab 72 configured to serve as an electrical path for inducing the current formed in the electrode assembly 40 to the exterior environment.

The rechargeable lithium battery 100 may be used in automobiles, mobile phones, and/or various types of electric devices, as non-limiting examples.

### Lithium Carbonate LCB

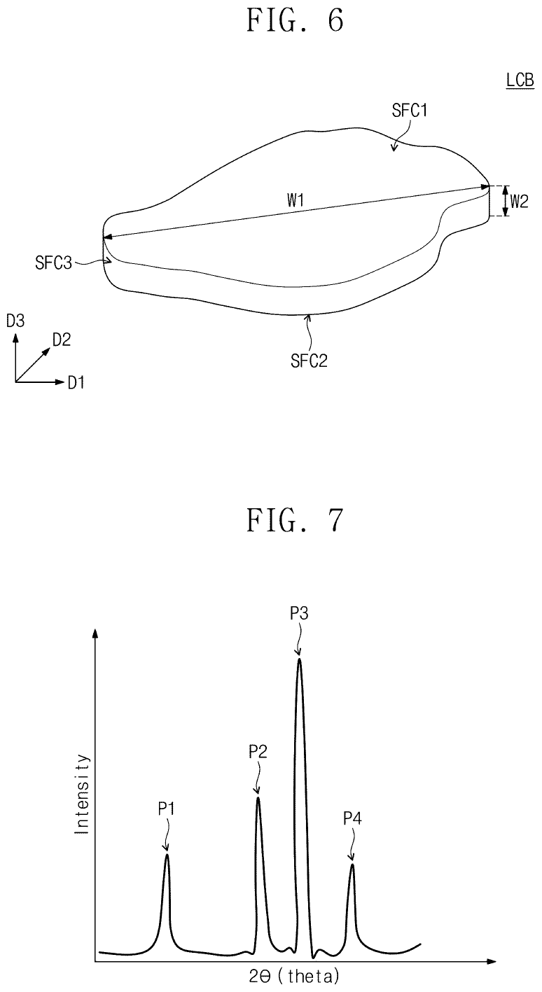

FIG. 6 is a schematic view showing a lithium carbonate according to embodiments of the present disclosure. FIG. 7 is an XRD spectrum of a lithium carbonate according to embodiments of the present disclosure.

Referring to FIG. 6, a lithium carbonate LCB may have a plate shape. In an embodiment, the lithium carbonate LCB may have a first surface SFC1 and a second surface SFC2 on a plane defined by a first direction D1 and a second direction D2. The first surface SFC1 and the second surface SFC2 may be opposite sides of each other. The lithium carbonate LCB may further include a third surface SFC3 between the first surface SFC1 and the second surface SFC2.

The first direction D1, the second direction D2, and the third direction D3 may be mutually orthogonal. The first direction D1 and the second direction D2 may be referred to as horizontal directions, and the third direction D3 may be referred to as a vertical direction.

Lithium carbonate and a transition metal-containing compound may be mixed and heat-treated to prepare a positive electrode active material including a lithium transition metal composite oxide. The plate-shaped lithium carbonate LCB may have a relatively large surface area (e.g., corresponding to the first surface SFC1 and the second surface SFC2) that is capable of reacting with the transition metal-containing compound during the heat treatment process. Accordingly, the plate-shaped lithium carbonate LCB is capable of reducing activation energy required for the reaction with the transition metal-containing compound during the heat treatment process, and is capable of facilitating the reaction with the transition metal-containing compound.

The lithium carbonate LCB may have a first width W1 and a second width W2. In an embodiment, the first width W1 may be greater than the second width W2. The first width W1 may correspond to a particle size of the lithium carbonate LCB. In an embodiment, the particle size may be an average particle diameter (D50). The second width W2 may correspond to a thickness of the lithium carbonate LCB. The thickness may be a shortest distance in the vertical direction between the first surface SFC1 and the second surface SFC2. In an embodiment, the thickness may be an average thickness.

In an embodiment, the average particle diameter (D50) may be measured by a method widely known to those skilled in the art, for example, by a particle size analyzer, an image of transmission electron microscope (TEM), or an image of scanning electron microscope (SEM). Alternatively, an average particle diameter (D50) value may be obtained by measuring a subject using a dynamic light-scattering-based measuring device, performing data analysis, counting the number of particles for each particle size range, then calculating the value. Also, a laser scattering method may be utilized to measure the average particle diameter. In the measurement using the laser diffraction method, target particles can be distributed in a distribution solvent, introduced into a commercially available laser diffraction particle diameter measuring device (e.g., MT 3000 available from Microtrac, Ltd.), irradiated with ultrasonic waves of about 28 kHz at a power of 60 W. Then an average particle diameter (D50) based on 50% of the particle diameter distribution in the measuring device may be calculated.

In an embodiment, the second width W2 may be measured through an image of transmission electron microscope (TEM) or scanning electron microscope (SEM).

In an embodiment, the first width W1 may be a largest width in the horizontal direction observed using an SEM. In an embodiment, the second width W2 may be a smallest width in the vertical direction observed using an SEM.

In an embodiment, the first width W1 may be about 3.5 μm to about 15 μm. In an embodiment, the second width W2 may be about 0.05 μm to about 3 μm. Under these conditions, the lithium carbonate LCB may be highly reactive when preparing the positive electrode active material, and a rechargeable lithium battery including the positive electrode active material may exhibit superior high-temperature lifespan characteristics.

The lithium carbonate LCB may have an aspect ratio of greater than about 1. In an embodiment, the lithium carbonate LCB may have an aspect ratio of about 10 to about 100, about 20 to about 80, or about 30 to about 70. The aspect ratio may be defined as a ratio of a particle size of the lithium carbonate LCB to a thickness of the lithium carbonate LCB (i.e., particle size of the lithium carbonate LCB/thickness of the lithium carbonate LCB). The aspect ratio may be defined as a ratio of the first width W1 to the second width W2 (i.e., W1/W2). Under these conditions, the lithium carbonate LCB may be highly reactive when preparing the positive electrode active material, and a rechargeable lithium battery including the positive electrode active material may exhibit superior high-temperature lifespan characteristics.

The lithium carbonate LCB may have a purity of about 95% to about 99.999%. In an embodiment, the lithium carbonate LCB may have a purity of about 95% or greater, about 97% or greater, about 99% or greater, and further, the lithium carbonate LCB may have a purity of about 99.999% or less, or about 99.99% or less. That is, the lithium carbonate LCB may be substantially free of impurities. The impurities may include Mn, Mg, Ca, Fe, Ni, Al, K, or Si. The impurities may be derived from compounds used in the process of preparing a high-nickel positive electrode active material or a lithium carbonate, impurities contained in the compounds, containers used in the preparation, or the like. Under these conditions, the lithium carbonate LCB may be highly reactive when preparing the positive electrode active material, and a rechargeable lithium battery including the positive electrode active material may exhibit superior high-temperature lifespan characteristics.

In an embodiment, the purity of lithium carbonate LCB may be determined through inductively coupled plasma spectrometry (ICP).

Referring to FIG. 7, the lithium carbonate LCB may include, in an XRD spectrum using a Cu-Kα line, a first peak P1 corresponding to a (110) plane, a second peak P2 corresponding to a (202) plane, a third peak P3 corresponding to a (002) plane, and a fourth peak P4 corresponding to a (112) plane.

In an embodiment, the first peak P1 may be observed in a diffraction angle (2θ) range of about 20° to about 23°. In an embodiment, the second peak P2 may be observed in a diffraction angle (2θ) range of about 30° to about 31.5°. In an embodiment, the third peak P3 may be observed in a diffraction angle (2θ) range of about 31.5° to about 34°. In an embodiment, the fourth peak P4 may be observed in a diffraction angle (2θ) range of about 34° to about 35°.

In an embodiment, in an XRD spectrum using a Cu-Kα line, a maximum peak intensity among the three peaks P1 to P3 may exist in the following order: P3>P2>P1. The maximum peak intensity of the fourth peak P4 may be substantially the same as the maximum peak intensity of the first peak P1, or may be less than the maximum peak intensity of the first peak P1.

A ratio of the maximum intensity of the third peak P3 to the maximum intensity of the first peak P1 (i.e., maximum intensity of P3/maximum intensity of P1, i.e., maximum intensity of (002) plane/maximum intensity of (110) plane) may be greater than about 1.0. A ratio of the maximum intensity of the third peak P3 to the maximum intensity of the first peak P1 (i.e., maximum intensity of (002) plane/maximum intensity of (110) plane) may range from about 1.1 to about 2.

A full width at half maximum (FWHM) of the first peak P1 and the third peak P3 may be relatively narrow. The first peak P1 may have a FWHM of about 0.0300 degrees to about 0.0500 degrees, or about 0.0400 degrees to about 0.0480 degrees. The third peak P3 may have a FWHM of about 0.100 degrees to about 0.177 degrees.

Under these conditions regarding the maximum intensity of the first peak to the maximum intensity of the third peak and the full width at half maximum of the first peak P1 and the third peak P3, the lithium carbonate LCB may be highly reactive when preparing the positive electrode active material, and a rechargeable lithium battery including the positive electrode active material may exhibit superior high-temperature lifespan characteristics.

Although not shown, the XRD spectrum using a Cu-Kα line for the lithium carbonate LCB may further include a plurality of other peaks in addition to the four peaks P1 to P4.

### Method for Preparing Lithium Carbonate LCB (S10)

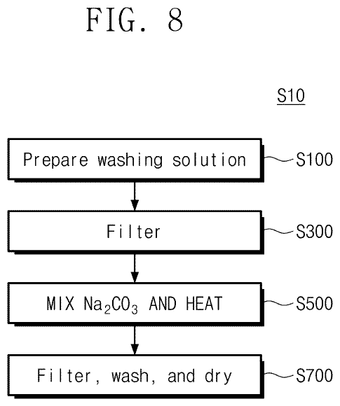

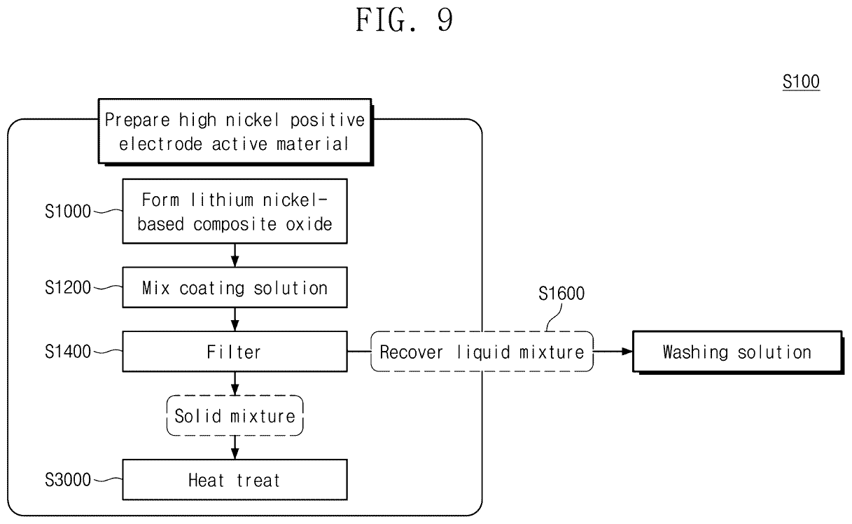

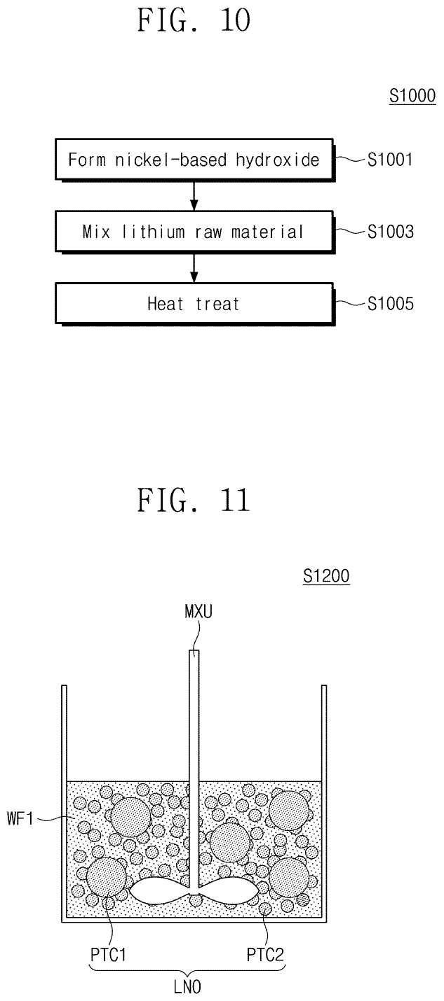

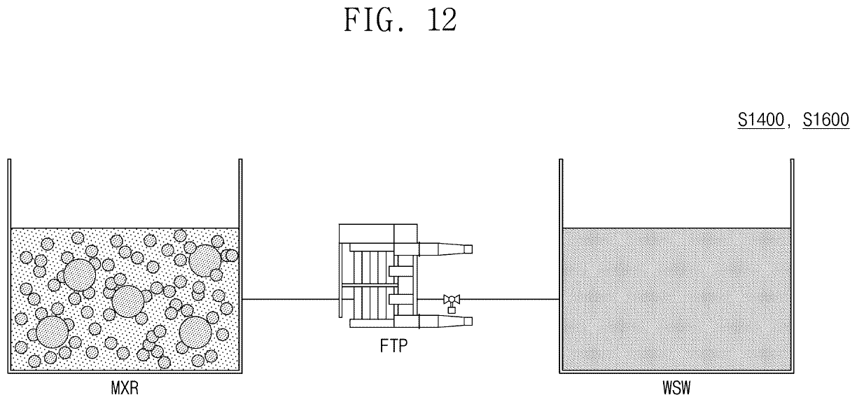

FIG. 8 is a flowchart showing a method for preparing a lithium carbonate (S10) according to embodiments of the present disclosure. FIG. 9 is a flowchart showing a method for preparing a lithium carbonate according to embodiments of the present disclosure. FIG. 10 is a flowchart showing a method for preparing a lithium carbonate according to embodiments of the present disclosure. FIG. 11 is a schematic view showing a method for preparing a lithium carbonate according to embodiments of the present disclosure. FIG. 12 is a schematic view showing a method for preparing a lithium carbonate according to embodiments of the present disclosure.

Referring to FIG. 8, the method for preparing a lithium carbonate LCB according to embodiments of the present disclosure may include preparing a washing solution (S100), filtering the washing solution (S300), mixing sodium carbonate to the filtered washing solution and heating the mixture (S500), and filtering, washing, and drying the mixture (S700).

Referring to FIG. 9, the washing solution may be obtained during a process of preparing a high-nickel positive electrode active material (S100). The method for manufacturing a high-nickel positive electrode active material may include forming a lithium nickel-based composite oxide (S1000), mixing a coating solution (S1200), filtering the mixture (S1400), and heat-treating a solid mixture in the mixture (S3000). In an embodiment, the preparation of the washing solution (S100) may include forming a lithium nickel-based composite oxide (S1000), mixing a coating solution (S1200), filtering the mixture (S1400), and recovering a liquid mixture in the mixture (S1600).

The high-nickel positive electrode active material may include a lithium nickel-based composite oxide. In an embodiment, a compound capable of reversibly intercalating and deintercalating lithium (lithiated intercalation compound) may be used as the high-nickel positive electrode active material.

The high-nickel positive electrode active material may include a lithium nickel-based composite oxide having a nickel (Ni) content of about 80 mol % to about 100 mol % among metals excluding lithium. In an embodiment, the high-nickel positive electrode active material may be a lithium nickel-based composite oxide having a nickel (Ni) content of about 85 mol % or greater or about 88% or greater among metals excluding lithium, and may be a lithium nickel-based composite oxide having a nickel (Ni) content of 100 mol % or less, 99 mol % or less, or 95 mol % or less.

Referring to FIG. 10, a preparation method including forming a nickel-based hydroxide (S1001), mixing the nickel-based hydroxide with a lithium raw material (S1003), and heat treating the mixture (S1005) may be used to prepare the lithium nickel-based composite oxide (S1000).

The nickel-based hydroxide may include a transition metal. The transition metal may include nickel (Ni), and may further include other transition metals excluding nickel. In an embodiment, the other transition metals may include Al, B, Ba, Ca, Ce, Co, Cr, Cu, Fe, Mg, Mn, Mo, Nb, Si, Sr, Ti, V, W, or Zr.

The nickel-based hydroxide may be obtained through co-precipitation (S1001). In an embodiment, the co-precipitation method may include dissolving transition metal raw materials in a solvent, such as distilled water, and continuously adding a transition metal salt solution into a reactor together with a chelating agent and/or a basic aqueous solution to cause precipitation. After collecting a precipitate in the form of a slurry, a slurry solution may be filtered and dried to obtain a nickel-based hydroxide, which is a metal composite oxide.

The transition metal raw material may include a salt of the transition metal. Sulfates, nitrates, acetates, halides, or hydroxides may be used, and is not particularly limited as long as the salt is dissolved in the solvent. In an embodiment, the transition metal raw material may include a nickel salt, a cobalt salt, and an aluminum salt. In an embodiment, the transition metal raw material may include a nickel salt, a cobalt salt, and a manganese salt. The transition metal raw material may be mixed by adjusting a molar ratio to allow a positive electrode active material to have high capacity characteristics.

The nickel-based hydroxide may be mixed with the lithium raw material at a certain ratio (S1003). In an embodiment, the nickel-based hydroxide and the lithium raw material may be mixed in a molar ratio of about 1:1. The lithium raw material is not particularly limited as long as it is a material typically used during preparation of a positive electrode active material. In an embodiment, the lithium raw material may include a lithium salt such as lithium carbonate, lithium nitrate, lithium hydroxide, or lithium sulfate.

A mixture of the nickel-based hydroxide and the lithium raw material may be placed into a furnace FRC and heat-treated (S1005). The heat treatment may be performed at a temperature of about 600° C. to about 1000° C. In an embodiment, the heat treatment may be performed at a temperature of about 700° C. to about 800° C. The heat treatment may be performed under an oxidating atmosphere including air or oxygen. The heat treatment may be performed for a duration of about 5 hours to about 30 hours. In an embodiment, preliminary firing may be further performed at a temperature of about 150° C. to about 800° C. prior to the heat treatment.

In an embodiment, a grinding process may be additionally performed after the heat treatment. Through the grinding process, a lithium nickel-based composite oxide having a desired average particle size may be obtained.

In an embodiment, the lithium nickel-based composite oxide may include at least one of a large particle (e.g., the first particle PTC1 of FIG. 11) and a small particle (e.g., the second particle, PTC2 of FIG. 11). The first particle and the second particle may each be prepared using the method of the present disclosure, then can be mixed. In an embodiment, the first particle and the second particle may be mixed in a weight ratio of about 95:5 to about 50:50. In an embodiment, the first particle and the second particle may be mixed in a weight ratio of about 5:95 to about 50:50. The first particle and the second particle, which may be different in average particle size, may be mixed and thus a bimodal type positive electrode active material may be prepared.

Referring to FIG. 11, a coating solution WF1 may be mixed with a lithium nickel-based composite oxide LNO (S1200). Through this step, cobalt (Co) may be applied onto a surface of the lithium nickel-based composite oxide LNO.

The coating solution WF1 may include a coating raw material, a precipitant (or pH adjuster), a solvent, or the like. The coating raw material may include a cobalt compound. The coating solution WF1 may coat and/or wash the lithium nickel-based composite oxide LNO. Residual lithium byproducts may be removed during the washing.

As to the cobalt compound, any material that is capable of applying cobalt can be used. In an embodiment, the cobalt compound may include cobalt nitrate, cobalt sulfate, cobalt oxide, cobalt hydroxide, or cobalt carbonate.

As to the precipitant (or pH adjuster), any material that may be used in precipitation can be used. In an embodiment, the precipitant (or pH adjuster) may include sodium hydroxide (NaOH), lithium hydroxide (LiOH), potassium hydroxide (KOH), or ammonia (NH₃).

The solvent may include distilled water, an alkaline solution, or the like.

The lithium nickel-based composite oxide LNO and the coating raw material may be uniformly mixed using a stirrer MXU.

Referring to FIG. 12, a mixture MXR generated via step S1200 may be filtered (S1400). During the filtering, the mixture may be separated into a solid mixture and a liquid mixture, and the liquid mixture may be recovered (S1600). The recovered liquid mixture may be defined as washing solution WSW.

The filtering may be performed using a filtering device typically used in the process of preparing a positive electrode active material. In an embodiment, the filtering may be performed through a filter portion FTP. In an embodiment, the filter portion FTP may be performed using a filter press. During the filtering, the solid mixture and the liquid mixture in the mixture may be separated. The separated solid mixture may be changed into a high-nickel positive electrode active material through heat treatment (S3000).

The recovering may be performed using a recovery device of the washing solution. The recovery device of the washing solution may include a tank portion, a valve portion, a line portion, a pump portion, or the like. The tank portion may include a plurality of tank portions. Any one or more of the plurality of tank portions may recover a liquid mixture. The liquid mixture recovered in the tank may include the washing solution WSW.

The washing solution WSW may include a high concentration of lithium (Li) and may be substantially free of impurities. In an embodiment, the washing solution may contain lithium (Li) at a concentration of about 1000 ppm or greater. In an embodiment, the washing solution may contain lithium (Li) at a concentration of about 1000 ppm to about 10000 ppm, about 2000 ppm to about 5000 ppm, or about 3500 ppm to about 5000 ppm. In an embodiment, the impurities in the washing solution WSW may include sodium (Na), potassium (K), magnesium (Mg), calcium (Ca), chlorine (Cl), sulfate (SO₄), or the like, and the impurities in the washing solution may be present at a concentration of about 20 ppm to about 40000 ppm. In an embodiment, the washing solution may contain sodium (Na) at a concentration of about 10000 ppm or less, or about 10 ppm to about 10000 ppm. In an embodiment, the washing solution may contain sulfate (SO₄) at a concentration of about 30000 ppm or less, or about 20 ppm to about 30000 ppm.

The washing solution WSW prepared using the method of the present disclosure may be used to prepare the lithium carbonate LCB.

Referring back to FIG. 8, before the preparing of the lithium carbonate LCB, the washing solution WSW may be filtered (S300). During the filtering, the remaining trace solid mixture may be removed. In an embodiment, although not shown, this step may be skipped.

The filtered washing solution WSW may be mixed with sodium carbonate (Na₂CO₃) and the mixture may be heated (S500). During this step, solid lithium carbonate may be formed in the mixture.

The washing solution WSW may have a pH of about 11 to about 13. In an embodiment, the washing solution WSW may have a pH of about 12 to about 13. Under these conditions, a lithium carbonate may be obtained at a high yield.

The heating may be performed at a temperature of about 50° C. to about 80° C. In an embodiment, the heating may be performed at a temperature of about 50° C. to about 70° C. The heating may be performed for about 30 minutes to about 300 minutes. Under these conditions, a lithium carbonate having a plate shape (e.g., LCB in FIG. 6) may be prepared.

In an embodiment, the filtered washing solution WSW may be heated, then sodium carbonate (Na₂CO₃) may be added thereto. In an embodiment, sodium carbonate (Na₂CO₃) may be added to the washing solution WSW, then the mixture may be heated.

The mixture may be filtered, washed, and dried, thereby obtaining a lithium carbonate (e.g., LCB in FIG. 6) (S700).

The filtering may be performed using a filtering device commonly used in the art. A solid lithium carbonate produced from filtering may be obtained. The remaining filtrate may be treated as wastewater or recycled.

The washing may be performed using distilled water.

The lithium (Li) content in the obtained lithium carbonate may range from about 50 wt % to about 96 wt % compared to the lithium content in the washing solution WSW. In an embodiment, the lithium (Li) content in the obtained lithium carbonate may range from about 70 wt % to about 86 wt % compared to the lithium content in the washing solution WSW.

In an embodiment, the process of preparing lithium phosphate from the washing solution, then carbonating the lithium phosphate, can be skipped. In an embodiment, the method may result in a high-purity lithium carbonate by using a washing solution substantially free of impurities and containing a relatively high concentration of lithium (Li).

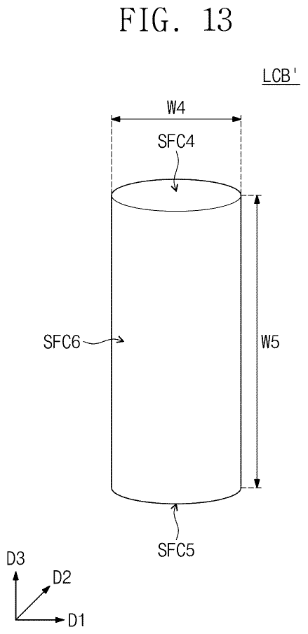

FIG. 13 is a schematic view showing a lithium carbonate LCB′ according to Comparative Example of the present disclosure.

The lithium carbonate LCB′ according to Comparative Example of the present disclosure may have a pillar shape. In an embodiment, the lithium carbonate LCB′ may have a fourth surface SFC4 and a fifth surface SFC5 on a plane defined by a first direction D1 and a second direction D2. The fourth surface SFC4 and the fifth surface SFC5 may be opposite ends of each other. The lithium carbonate LCB′ may further include a sixth surface SFC6 between the fourth and fifth surfaces SFC4 and SFC5. The shape of the fourth surface SFC4 and the fifth surface SFC5 is not limited and may be circular, polygonal, or irregular.

The pillar-shaped lithium carbonate LCB′ may have a relatively narrow surface are (e.g., the fourth surface SFC4 and the fifth surface SFC5) that is capable of reacting with a transition metal-containing compound during a heat treatment process. Accordingly, the pillar-shaped lithium carbonate LCB′ may have a relatively high activation energy required for the reaction with the transition metal-containing compound during the heat treatment process, and may exhibit relatively lower reactivity with the transition metal-containing compound.

The lithium carbonate LCB′ may have a fourth width W4 and a fifth width W5. In an embodiment, the fourth width W4 may be smaller than the fifth width W5. In an embodiment, the fourth width W4 may be a largest width in a horizontal direction in an SEM image of the lithium carbonate LCB′. In an embodiment, the fifth width W5 may be a smallest width in a vertical direction in an SEM image of the lithium carbonate LCB′.

The lithium carbonate LCB′ may have an aspect ratio of less than about 1. The aspect ratio of the lithium carbonate LCB′ may be defined as a ratio of the fourth width W4 to the fifth width W5 (i.e., W4/W5).

In an embodiment, the fourth surface SFC4 and the fifth surface SFC5 are not necessarily limited to the shape of a surface, and may also be in a three-dimensional shape such as a conical shape or a polyhedral shape.

The lithium carbonate LCB′ may have a purity of about 99.99% to about 99.999%.

In an XRD spectrum using a Cu-Kα line, lithium carbonate LCB′ may have a ratio of a maximum intensity of a third peak P3 to a maximum intensity of a first peak P1 (maximum intensity of (002) plane/maximum intensity of (110) plane) of greater than about 2.0.

A full width at half maximum of the first peak P1 and the third peak P3 may each be greater than a full width at half maximum of the first peak P1 and the third peak P3 of the plate-shaped lithium carbonate.

The lithium carbonate LCB′ may be prepared via heat treatment at a higher temperature than previously disclosed in step S500 during the preparation process of FIG. 8.

The lithium carbonate LCB′ may exhibit relatively low reactivity in a process of preparing a positive electrode active material, and a rechargeable lithium battery including a positive electrode active material prepared with the lithium carbonate LCB′ may exhibit relatively low high-temperature lifespan characteristics.

### Method for Preparing Positive Electrode Active Material CAM

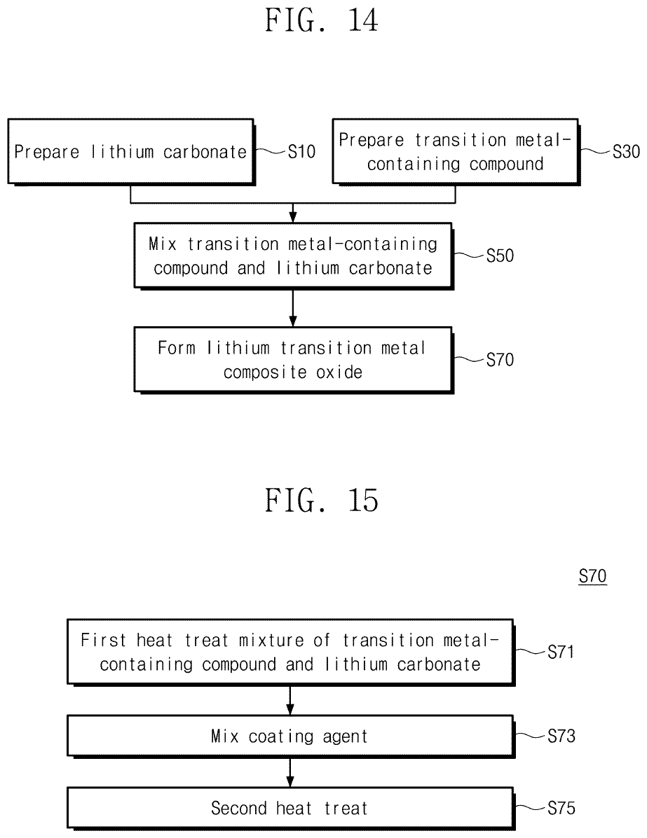

FIG. 14 is a flowchart showing a method for preparing a positive electrode active material CAM according to embodiments of the present disclosure. FIG. 15 is a flowchart showing an embodiment of step S70.

Referring to FIG. 14, the method for preparing a positive electrode active material CAM may include preparing a lithium carbonate (S10), preparing a transition metal-containing compound (S30), mixing the transition metal-containing compound and the lithium carbonate (S50), and forming a lithium transition metal composite oxide (S70).

The lithium carbonate LCB is referred in FIGS. 6 and 7. The lithium carbonate LCB may be prepared using the preparation method referred in FIGS. 8 to 12 (S10).

The prepared transition metal-containing compound and the lithium carbonate may be mixed and heat-treated to form a lithium transition metal composite oxide (S30, S50, S70). In an embodiment, a grinding process may be additionally performed after the heat treatment. During the grinding process, a lithium nickel-based composite oxide, having a desired average particle size, may be obtained. The lithium transition metal composite oxide may include a lithium nickel-based oxide, a lithium cobalt-based oxide, a lithium manganese-based oxide, a lithium iron phosphate-based compound, a cobalt-free nickel-manganese-based oxide, or a combination thereof.

In an embodiment, steps S30 to S70 may refer to the lithium transition metal composite oxide being a lithium nickel-based composite oxide.

The transition metal-containing compound may include a nickel-based hydroxide. The nickel-based hydroxide may be obtained through co-precipitation (S30). In an embodiment, the co-precipitation method may include dissolving transition metal raw materials in a solvent, such as distilled water, and continuously adding a transition metal salt solution into a reactor together with a chelating agent and/or a basic aqueous solution to cause precipitation. After collecting a precipitate in the form of a slurry, a slurry solution may be filtered and dried to obtain a nickel-based hydroxide, which is a metal composite oxide.

The nickel-based hydroxide may be mixed with a lithium carbonate in a certain ratio (S50). In an embodiment, the nickel-based hydroxide and the lithium carbonate may be mixed in a molar ratio of about 1:1.

The mixture of nickel-based hydroxide and lithium carbonate may be placed into a furnace and heat-treated (S70) to prepare a lithium nickel-based composite oxide. Referring to FIG. 15, this step (S70) may include a first heat treatment of the mixture of nickel-based hydroxide and lithium carbonate (S71), mixing a coating agent (S73), and second heat treatment of the mixture (S75).

The first heat treatment may be performed at a temperature of about 600° C. to about 1000° C. In an embodiment, the first heat treatment may be performed at a temperature of about 700° C. to about 800° C. The first heat treatment may be performed for a duration of about 5 hours to about 30 hours. In an embodiment, preliminary firing may be further performed prior to the first heat treatment.

The coating agent may include a transition metal oxide. In an embodiment, the transition metal oxide may include at least one selected from the group consisting of titanium dioxide (TiO₂), magnesium oxide (MgO), aluminum oxide (Al₂O₃), boron oxide (B₂O₃), and zirconium oxide (ZrO₂). The transition metal oxide and the coating agent may be dry mixed.

The second heat treatment may be performed at a temperature of about 500° C. to about 800° C. In an embodiment, the second heat treatment may be performed at a temperature of about 600° C. to about 800° C. The second heat treatment may be performed for a duration of about 5 hours to about 30 hours.

When the lithium transition metal composite oxide is a lithium cobalt-based composite oxide, the transition metal-containing compound may include a cobalt-based oxide (S30). The cobalt-based oxide may be mixed with a lithium carbonate at a certain ratio (S50). In an embodiment, the cobalt-based oxide and the lithium carbonate may be mixed in a molar ratio of about 1:1. The mixture of cobalt-based oxide and lithium carbonate may be placed into a furnace and heat treated (S70) to prepare a lithium cobalt-based composite oxide. The heat treatment may be performed at a temperature of about 900° C. to about 1,200° C. The heat treatment may be performed for a duration of about 5 hours to about 30 hours.

### Positive Electrode Active Material CAM

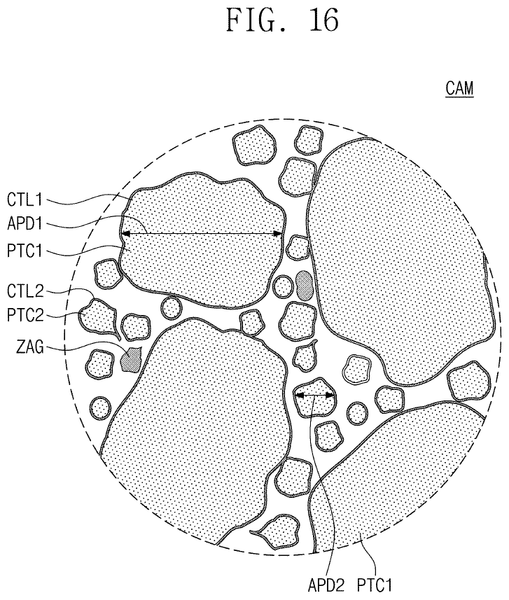

FIG. 16 is a cross-sectional view showing a positive electrode active material CAM according to embodiments of the present disclosure. The positive electrode active material CAM of FIG. 16 is shown existing in a powder form before being used in a positive electrode active material layer AML1 described with reference to FIG. 1.

The positive electrode active material CAM may include at least one of a plurality of first particles PTC1 or a plurality of second particles PTC2. The plurality of first particles PTC1 and the plurality of second particles PTC2 may each be the first particles and the second particles referred in FIG. 11. In an embodiment, the positive electrode active material CAM may include the plurality of first particles PTCL. In an embodiment, the positive electrode active material CAM may include the plurality of second particles PTC2. In an embodiment, the positive electrode active material CAM may include the plurality of first particles PTC1 and the plurality of second particles PTC2.

The plurality of first particles PTC1 may each have a first average particle diameter APD1, and the plurality of second particles PTC2 may each have a second average particle diameter APD2. In an embodiment, the first average particle diameter APD1 may be greater than the second average particle diameter APD2. The first average particle diameter APD1 may range from about 5 μm to about 25 μm. In an embodiment, the first average particle diameter APD1 may range from about 7 μm to about 25 μm, about 10 μm to about 25 μm, about 15 μm to about 25 μm, or about 10 μm to about 20 μm. The second average particle diameter APD2 may range from about 0.1 μm to about μm. In an embodiment, the second average particle diameter APD2 may be range from about 0.1 μm to about 7 μm, about 0.5 μm to about 6 μm, or about 1 μm to about 5 μm.

In an embodiment, the average particle diameter may be obtained by measuring a particle diameter by randomly selecting about 30 first particles and second particles on an electron microscope image of a positive electrode active material, and taking the diameter of particles at an accumulated volume of about 50 vol % in particle size distribution as an average particle diameter. In an embodiment, the average particle diameter may be obtained by taking the diameter of particles at an accumulated volume of about 50 vol % in particle size distribution as an average particle diameter, as measured by a particle size analyzer.

The positive electrode active material CAM may exist in a bimodal form including the plurality of first particles PTC1 and the plurality of second particles PTC2, where the average particle diameter may differ. Voids between the plurality of first particles PTC1 may be filled with the plurality of second particles PTC2, and thus the positive electrode active material layer AML1 may have enhanced packing density. That is, the positive electrode active material layer AML1 may have a relatively high capacity and high energy density per unit volume.

In an embodiment, the plurality of first particles PTC1 and the plurality of second particles PTC2 may exist in a weight ratio of about 95:5 to about 50:50. In an embodiment, the plurality of first particles PTC1 and the plurality of second particles PTC2 may exist in a weight ratio of about 5:95 to about 50:50. In an embodiment, in the positive electrode active material CAM, the weight of the plurality of first particles PTC1 may be greater than the weight of the plurality of second particles PTC2.

In an embodiment, the positive electrode active material CAM may include only the plurality of first particles PTC1. That is, the plurality of second particles PTC2 may not be provided.

In an embodiment, the plurality of first particles PTC1 may each be in a polycrystal form and may include a secondary particle in which at least two primary particles PRP are aggregated. The plurality of first particles PTC1 may each be either granular or spherical in shape.

In an embodiment, the plurality of first particles PTC1 may each be in the form of a single particle, present alone with no grain boundaries therein, and exist as a single particle, may have a monolith structure or a one-body structure, in which particles are not mutually aggregated but are present as an independent phase in terms of morphology, or exist as a non-aggregated particle. In an embodiment, the plurality of first particles PTC1 may exist in a single crystalline form. The single particle form may include one crystal grain or several crystal grains. The crystal grain may be a smallest unit having a single crystal direction. In an embodiment, the single particle form may include one primary particle and/or one single particle in which a plurality of primary particles are merged into a single body. The plurality of first particles PTC1 may each be spherical or elliptical. Alternatively, the plurality of first particles PTC1 may be polyhedral or irregular.

In an embodiment, the plurality of second particles PTC2 may each be in the form of a single particle, present alone with no grain boundaries therein, and exist as a single particle, may have a monolith structure or a one-body structure, in which particles are not mutually aggregated but are present as an independent phase in terms of morphology, or exist as a non-aggregated particle. In an embodiment, the plurality of second particles PTC2 may exist in a single crystalline form. The single particle form may include one crystal grain or several crystal grains. The crystal grain may be a smallest unit having a single crystal direction. In an embodiment, the single particle form may include one primary particle and/or one single particle in which a plurality of primary particles are merged into a single body. The plurality of second particles PTC2 may each be spherical or elliptical. Alternatively, the plurality of second particles PTC2 may be polyhedral or irregular. The positive electrode active material CAM may include the plurality of second particles PTC2, and may thus exhibit high capacity, high energy density, and enhanced lifespan characteristics.

The plurality of first particles PTC1 and the plurality of second particles PTC2 may each include a lithium transition metal composite oxide. A compound capable of reversibly intercalating and deintercalating lithium (lithiated intercalation compound) may be used as each of the plurality of first particles PTC1 and the plurality of second particles PTC2. In an embodiment, at least one of a composite oxide of lithium and a metal selected from cobalt, manganese, nickel, and a combination thereof may be used.

The composite oxide may be a lithium transition metal composite oxide, and non-limiting examples include lithium nickel-based oxide, lithium cobalt-based oxide, lithium manganese-based oxide, lithium iron phosphate-based compound, cobalt-free nickel-manganese-based oxide, or a combination thereof.

In an embodiment, the lithium nickel-based composite oxide may include a lithium nickel-based composite oxide including a high content of nickel (Ni). In an embodiment, the lithium nickel-based oxide may include a lithium nickel-based composite oxide having a nickel (Ni) content of about 50 mol % or greater, 60 mol % or greater, about 80 mol % or greater, about 90 mol % or greater, or about 91 mol % or greater, and about 100 mol % or less, about 99.9 mol % or less, or about 99 mol % or less, among metals excluding lithium. That is, the lithium nickel-based composite oxide may include a lithium nickel-based composite oxide having a nickel (Ni) content of about 60 mol % or greater, about 80 mol % or greater, about 90 mol % or greater, or about 91 mol % or greater, and about 100 mol % or less, about 99.9 mol % or less, or about 99 mol % or less, with respect to a total moles of transition metals. Under these conditions, the positive electrode active material CAM may achieve high capacity and high performance.

In an embodiment, the lithium transition metal composite oxide including the plurality of first particles PTC1 and the plurality of second particles PTC2 may be represented by Formula 1.

Liₐ₁Niₓ₁M¹_{y1}M²_{z1}O_{2-b1}X_{b1} [Formula 1]

where a1, x1, y1, z1, and b1 satisfy 0.8≤a1≤1.8, 0.5≤x1≤1, 0≤y1≤0.5, 0≤z1≤0.2, 0.9≤x1+y1+z1≤1.1, and 0≤b1≤0.1, M¹ and M² are each independently at least one element selected from aluminum (Al), boron (B), barium (Ba), calcium (Ca), cerium (Ce), cobalt (Co), chromium (Cr), copper (Cu), iron (Fe), magnesium (Mg), manganese (Mn), molybdenum (Mo), niobium (Nb), silicon (Si), strontium (Sr), titanium (Ti), vanadium (V), tungsten (W), and zirconium (Zr), and X is at least one element selected from the group consisting of fluorine (F), phosphorus (P), and sulfur (S). In an embodiment, x1+y1+z1=1 may be satisfied.

In an embodiment, the lithium transition metal composite oxide including the plurality of first particles PTC1 and the plurality of second particles PTC2 may be represented by Formula 2. The compound represented by Formula 2 may include a lithium nickel cobalt-based composite oxide.

Liₐ₂Niₓ₂Co_{y2}M³_{z2}O_{2-b2}X_{b2} [Formula 2]

where a2, x2, y2, z2, and b2 satisfy 0.8≤a2≤1.8, 0.5≤x2≤1, 0≤y2≤0.5, 0≤z2≤0.2, 0.9≤x2+y2+z2≤1.1, and 0≤b2≤0.1, M³ is at least one element selected from Al, B, Ba, Ca, Ce, Cr, Fe, Mg, Mn, Mo, Nb, Si, Sr, Ti, V, W, and Zr, and X is at least one element selected from F, P, and S. For example, x2+y2+z2=1 may be satisfied.

In an embodiment, the lithium transition metal composite oxide including the plurality of first particles PTC1 and the plurality of second particles PTC2 may be represented by Formula 3. The compound represented by Formula 3 may include a lithium nickel cobalt aluminum oxide or a lithium nickel cobalt manganese oxide.

Liₐ₃Niₓ₃CO_{y3}M⁴_{z3}M⁵_{w3}O_{2-b3}X_{b3} [Formula 3]

where a3, x3, y3, z3, w3, and b3 satisfy 0.8≤a3≤1.8, 0.5≤x3≤0.98, 0.01≤y3≤0.49, 0.01≤z3≤0.49, 0≤w3≤0.49, 0.9≤x3+y3+z3+w3≤1.1, and 0≤b3≤0.1, M⁴ is at least one selected from Al and Mn, M⁵ is at least one element selected from B, Ba, Ca, Ce, Cr, Fe, Mg, Mo, Nb, Si, Sr, Ti, V, W, and Zr, and X is at least one element selected from F, P, and S. In an embodiment, x3+y3+z3+w3=1 may be satisfied.

In an embodiment, the lithium transition metal composite oxide including the plurality of first particles PTC1 and the plurality of second particles PTC2 may be represented by Formula 4. The compound of Formula 4 may include a cobalt-free lithium nickel-manganese-based oxide.

Liₐ₄Niₓ₄Mn_{y4}M⁶_{z4}O_{2-b4}X_{b4} [Formula 4]

where a4, x4, y4, z4, and b4 satisfy 0.8≤a4≤1.8, 0.5≤x4≤1, 0≤y4≤0.5, 0≤z4≤0.5, 0.9≤x4+y4+z4≤1.1, and 0≤b4≤0.1, M⁶ is at least one element selected from Al, B, Ba, Ca, Ce, Cr, Fe, Mg, Mo, Nb, Si, Sr, Ti, V, W, and Zr, and X is at least one element selected from F, P, and S.

In an embodiment, the lithium transition metal composite oxide including the plurality of first particles PTC1 and the plurality of second particles PTC2 may be represented by Formula 5. The compound of Formula 5 may include a lithium cobalt-based oxide.

Liₐ₅Coₓ₅M⁷₁₋ₓ₅O₂ [Formula 5]

where a5 and x5 satisfy 0.8≤a5≤1.8 and 0.6≤x5≤1, M⁷ is at least one element selected from Al, B, Ba, Ca, Ce, Cr, Cu, F, Fe, Mg, Mn, Mo, Nb, P, S, Si, Sr, Ti, V, W, and Zr.

In an embodiment, the lithium transition metal composite oxide including the plurality of first particles PTC1 and the plurality of second particles PTC2 may be represented by Formula 6. The compound of Formula 6 may include a lithium iron phosphate-based compound.

Liₐ₆Feₓ₆M⁸₁₋ₓ₆PO₄ [Formula 6]

where a6 and x6 satisfy 0.8≤a6≤1.8 and 0.6≤x6≤1, M⁸ is at least one element selected from Al, B, Ba, Ca, Ce, Co, Cr, Cu, F, Fe, Mg, Mn, Mo, Nb, P, S, Si, Sr, Ti, V, W, and Zr.

The positive electrode active material CAM may further include a first coating layer CTL1 and a second coating layer CTL2, each of which positioned on a surface of the plurality of first particles PTC1 and the plurality of second particles PTC2, respectively. The first coating layer CTL1 and the second coating layer CTL2 may be positioned on an entire portion or at least a portion of the surfaces of the plurality of first particles PTC1 and the plurality of second particles PTC2. In the first coating layer CTL1 and the second coating layer CTL2, structural collapse induced by repeated charge and discharge may be effectively suppressed, resulting in enhanced room temperature and high temperature lifespan characteristics.

The first coating layer CTL1 and the second coating layer CTL2 may include a transition metal and/or a transition metal-containing compound. In an embodiment, the first coating layer CTL1 and the second coating layer CTL2 may include nickel, cobalt, or aluminum, but are not limited thereto. In an embodiment, the transition metal-containing compound may include a transition metal oxide, a transition metal hydroxide, a transition metal carbonate, a composite thereof, or a mixture thereof.

The positive electrode active material CAM may further include a grain boundary coating portion positioned on surfaces of primary particles inside the plurality of first particles PTCL. The grain boundary coating portion may be present in an inner portion rather than a surface of the secondary particle, and may be coated along an interface of the primary particles inside the secondary particle, and thus may be described as grain boundary coated. The inner portion of the secondary particle may indicate an entire inner portion except for the surface and, in an embodiment, may indicate an entire inner portion from a depth of approximately 10 nm with respect to an outer surface, or a region from a depth of about 10 nm to a depth of about 2 μm. In the plurality of first particles PTC1, the inclusion of the grain boundary coating portion may result in enhanced structural stability, a uniform and even coating on the surface, and proper adjustment of the coating content on the surface to obtain initial charge/discharge efficiency and lifespan characteristics without an increase in resistance.

The positive electrode active material CAM may further include an aggregate ZAG. The aggregate ZAG may be provided in a space between the plurality of first particles PTC1 and the plurality of second particles PTC2. The aggregate ZAG may be derived from a process of forming the first coating layer CTL1, the second coating layer CTL2, and the grain boundary coating portion.

The positive electrode active material CAM may be prepared via a preparation method according to embodiments of the disclosure. The positive electrode active material CAM may be prepared using a lithium carbonate. A rechargeable lithium battery including the positive electrode active material CAM may exhibit excellent high-temperature lifespan characteristics. In an embodiment, a rechargeable lithium battery may have a capacity retention of at least 90% when charged and discharged 30 times at 1 C/1 C at 45° C.

The present disclosure will be described in more detail through Examples. However, Examples are only illustrations for describing the present disclosure, and the scope of the present disclosure is not limited to Examples.

### Example

Ni_{0.88}Co_{0.09}Al_{0.03}(OH)₂ and lithium hydroxide (LiOH) were mixed and fired, and a coating solution containing cobalt sulfate (CoSO₄), sodium hydroxide (NaOH), and distilled water was added to the mixture. The liquid mixture was recovered through filtration, thereby preparing a washing solution containing 4450 ppm of lithium (Li).

The washing solution was filtered to remove the remaining trace solid mixture. Sodium carbonate (Na₂CO₃) was mixed with the filtered washing solution and the mixture was heated. The heating was performed at about 60° C. for 60 minutes. The mixture was filtered, washed with distilled water, and dried to prepare a plate-shaped lithium carbonate (Li₂CO₃).

Nickel-based hydroxide (Ni_{0.50}Co_{0.20}Mn_{0.30}(OH)₂) and the plate-shaped lithium carbonate were dry mixed in a molar ratio of about 1:1 using a Henschel mixer, then subjected to a first heat treatment at about 750° C. for 15 hours. Titanium dioxide (TiO₂) was added to the mixture subjected to the first heat treatment and dry mixed using a Henschel mixer, then subjected to a second heat treatment at about 700° C. for 15 hours. A positive electrode active material including lithium nickel oxide (Formula: approximately LiNi_{0.50}Co_{0.20}Mn_{0.30}O₂) was prepared.

### Comparative Example

A positive electrode active material was prepared in the same manner as in Example, except that a pillar-shaped lithium carbonate (Li₂CO₃) was prepared by mixing sodium carbonate (Na₂CO₃) with the filtered washing solution and heating the mixture at about 90° C. Instead of the plate-shaped lithium carbonate, nickel-based hydroxide (Ni_{0.50}Co_{0.20}Mn_{0.30}(OH)₂) and a pillar-shaped lithium carbonate were dry mixed in a molar ratio of about 1:1 using a Henschel mixer.

### Preparation of Positive Electrode

95 wt % of a final positive electrode active material, 3 wt % of a polyvinylidene fluoride binder, and 2 wt % of a carbon black conductive material were mixed in an N-methylpyrrolidone solvent to prepare a positive electrode active material slurry. The positive electrode active material slurry was applied onto an aluminum current collector, dried and rolled to prepare a positive electrode.

### Preparation of Rechargeable Lithium Battery

A 2032 type coin half cell was prepared using the prepared positive electrode and a lithium metal counter electrode as a counter electrode. A separator (thickness: about 16 m) formed of a porous polyethylene (PE) film was placed between the positive electrode and the lithium metal counter electrode, and an electrolyte solution was injected to prepare a rechargeable lithium battery. An electrolyte solution was obtained by mixing 1.3 M LiPF₆ with a mixed solvent containing ethylene carbonate (EC), ethylmethyl carbonate (EMC), and dimethyl carbonate (DMC) in a volume ratio of 3:4:3.

### Experimental Example 1: Analysis of Lithium Carbonate (1)

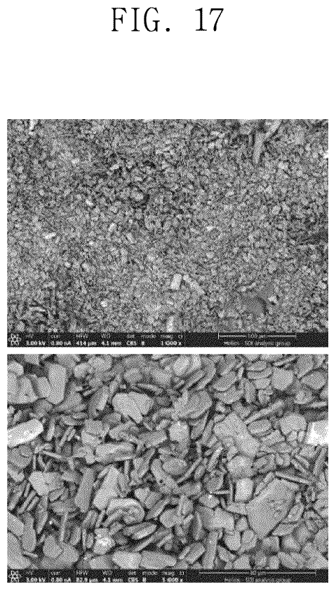

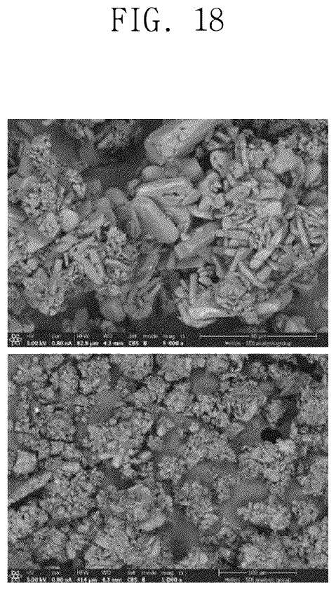

FIGS. 17 and 18 show SEM images of lithium carbonates obtained from Example and Comparative Example. The lithium carbonate from Example had a plate-shaped structure, while the lithium carbonate from Comparative Example had a pillar-shaped structure.

An aspect ratio was calculated by taking a largest width in a horizontal direction of the plate-shaped lithium carbonate observed in FIG. 17 as a first width, and a smallest width in a vertical direction as a second width. When the results of calculating the aspect ratio of about 50 plate-shaped lithium carbonates were averaged, the result was about 50. An aspect ratio was calculated by taking a largest width in a horizontal direction of the pillar-shaped lithium carbonate observed in FIG. 18 as a fourth width, and a smallest width in a vertical direction as a fifth width. When the results of calculating the aspect ratio of about 50 pillar-shaped lithium carbonates were averaged, the result was about 0.2.

### Experimental Example 2: Analysis of Lithium Carbonate (2)

The composition and content of lithium carbonates from Example and Comparative Example were analyzed using ICP. The results are shown in Table 1. The content of all elements excluding water (H₂O) was measured in units of parts per million (ppm).

TABLE 1

| Item | Mn | Mg | Ca | Zn | Cu | Fe | Na | Al | K | Cr | Cd | Pb | Si | H₂O |
|---|---|---|---|---|---|---|---|---|---|---|---|---|---|---|
| Example | 1 | 48 | 107 | 0 | 0 | 3 | 538 | 9 | 10 | 0 | 0 | 0 | 62 | 0.06% |
| Comparative | 1 | 1 | 3 | 0 | 0 | 0 | 40 | 1 | 9 | 0 | 0 | 0 | 2 | 0.04% |
| Example | | | | | | | | | | | | | | |

Referring to Table 1, the lithium carbonate of Example had a purity of about 99.92%, and the lithium carbonate of Comparative Example had a purity of about 99.99%.

### Experimental Example 3: Analysis of Lithium Carbonate (3)

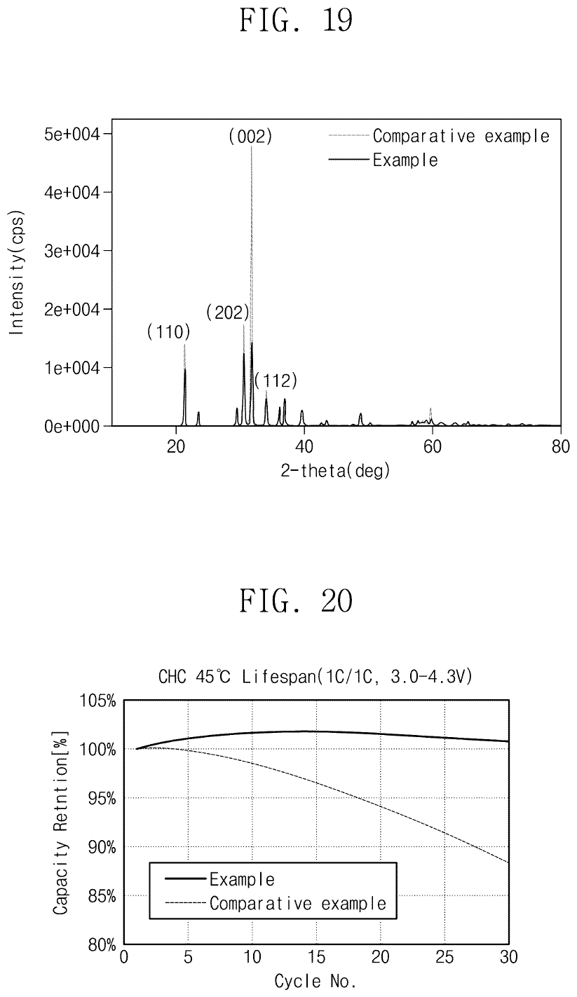

FIG. 19 is an XRD spectrum using a Cu-Kα line of lithium carbonates from Example and Comparative Example. The lithium carbonates from Example and Comparative Example included peaks each corresponding to (110) plane, (202) plane, (002) plane, and (112) plane. The ratio of maximum intensity of (002) plane/maximum intensity of (110) plane and the full width at half maximum are shown in Table 2.

TABLE 2

| | Ratio of maximum | Full width | Full width |
|---|---|---|---|
| | intensity of (002) | at half | at half |
| | plane/maximum intensity | maximum of | maximum of |
| Item | of (110) plane | (110) peak | (002) peak |
| Example | 1.4 | 0.044 | 0.175 |
| Comparative | 3.3 | 0.054 | 0.179 |
| Example | | | |

Referring to Table 2, the lithium carbonate from Example had a smaller ratio of the maximum intensity of the (002) plane/the maximum intensity of the (110) plane than the lithium carbonate from Comparative Example. In addition, the lithium carbonate from Example had a smaller full width at half maximum of the (110) peak and the (002) peak than the lithium carbonate from Comparative Example.

### Experimental Example 4: Evaluation of Battery Life at High Temperature

Rechargeable lithium batteries including the positive electrode active materials according to Example and Comparative Example were evaluated for high-temperature lifespan characteristics. For initial charging/discharging, the rechargeable lithium batteries were initially charged to 4.3 V under constant current (0.1 C) conditions, and after 10 minutes of rest, discharged to 3.0 V under constant current (0.1 C) conditions, and then repeatedly charged and discharged 30 times at 1 C/1 C at 45° C. to evaluate the high-temperature lifespan characteristics. The results are shown in FIG. 20.

Referring to FIG. 20, it is determined that the rechargeable lithium battery including Example has superior high-temperature lifespan characteristics than the rechargeable lithium battery including Comparative Example.

Advantageously, the lithium carbonate according to embodiments of the present disclosure exhibits excellent purity, and the rechargeable lithium battery including the positive electrode active material prepared using the lithium carbonate exhibits excellent high-temperature lifespan characteristics.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A method for preparing a lithium carbonate, the method comprising:
combining a lithium nickel-based composite oxide and a coating solution to form a first mixture, wherein the coating solution comprises a coating raw material;
recovering a washing solution from the first mixture, wherein the washing solution comprises at least 1000 ppm of lithium;
combining the washing solution and sodium carbonate to form a second mixture; and
heating the second mixture at a temperature of about 50° C. to about 80° C.

2. The method of claim 1, wherein the lithium nickel-based composite oxide has a nickel content of about 80 mol % to about 100 mol % among metals excluding lithium.

3. The method of claim 1, wherein the coating raw material comprises a cobalt compound.

4. The method of claim 3, wherein the cobalt compound comprises at least one selected from the group of cobalt nitrate, cobalt sulfate, cobalt oxide, cobalt hydroxide, and cobalt carbonate.

5. The method of claim 1, wherein the precipitant comprises at least one selected from the group of sodium hydroxide, lithium hydroxide, potassium hydroxide, and ammonia.

6. The method of claim 1, wherein the washing solution comprises about 3500 ppm to about 5000 ppm of lithium.

7. The method of claim 1, wherein the washing solution comprises impurities at a concentration of about 20 ppm to about 40000 ppm.

8. The method of claim 1, wherein the heating is performed for 30 to 300 minutes.

9. The method of claim 1, wherein the coating solution further comprises a precipitant and a solvent.

10. The method of claim 1, further comprising filtering the washing solution.

11. The method of claim 1, further comprising filtering, washing, and drying the second mixture.

12. A lithium carbonate having a plate shape and comprising:
a first width in a horizontal direction ranging from about 3.5 μm to about 15 μm; and
a second width in a vertical direction ranging from about 0.05 μm to about 3 μm,
wherein the lithium carbonate is configured to reduce activation energy of a reaction with a transition metal-containing compound to form a positive electrode active material of a rechargeable lithium battery.

13. The lithium carbonate of claim 12, wherein the lithium carbonate has an aspect ratio of about 10 to about 100.

14. The lithium carbonate of claim 12, wherein the lithium carbonate has a purity of about 95% to about 99.999%.

15. The lithium carbonate of claim 12, wherein in an XRD spectrum of the lithium carbonate using a Cu-Kα line, a ratio of a maximum intensity of a (002) plane to a maximum intensity of a (110) plane ranges from about 1.1 to about 2.

16. The lithium carbonate of claim 12, wherein in an XRD spectrum of the lithium carbonate using a Cu-Kα line, a full width at half maximum of a peak corresponding to the (110) plane ranges from about 0.0300 degrees to about 0.0500 degrees.

17. The lithium carbonate of claim 12, wherein in an XRD spectrum of the lithium carbonate using a Cu-Kα line, a full width at half maximum of a peak corresponding to the (002) plane ranges from about 0.100 degrees to about 0.177 degrees.

18. A rechargeable lithium battery comprising a positive electrode active material prepared by mixing and heat treating the lithium carbonate described in claim 12 and a transition metal-containing compound.

19. The rechargeable lithium battery of claim 18, wherein the positive electrode active material comprises a lithium nickel-based composite oxide having a nickel content of about 50 mol % to about 100 mol % among metals excluding lithium.

20. The rechargeable lithium battery of claim 18, wherein the rechargeable lithium battery has a capacity retention of at least 90% when charged and discharged 30 times at 1 C/1 C at 45° C.
